(19) United States
(12) Patent Application Publication
(10) Pub. No.: US 2025/0209597 A1
(43) Pub. Date: Jun. 26, 2025

(54) SUBSTRATE INSPECTING APPARATUS AND METHOD OF INSPECTING SUBSTRATE

(71) Applicant: Samsung Display Co., Ltd., Yongin-Si (KR)

(72) Inventors: MYOUNGCHUL KIM, Yongin-si (KR); TAEJUN KIM, Yongin-si (KR); TAE-GU KANG, Yongin-si (KR); INHYE PARK, Yongin-si (KR); JIHOON SEO, Yongin-si (KR); YOSEPH SON, Yongin-si (KR); EON PIL SHIN, Yongin-si (KR); GIJOUNG JANG, Yongin-si (KR)

(21) Appl. No.: 18/946,949

(22) Filed: Nov. 14, 2024

(30) Foreign Application Priority Data
Dec. 22, 2023 (KR) 10-2023-0190511

(51) Int. Cl. G06T 7/00

(52) U.S. Cl. CPC G06T 7/0004; G06T 2207/20221; G06T 2207/30148

(57) ABSTRACT

A substrate inspecting apparatus includes an image sensor that captures an image of a substrate to generate basic image data, and a merger that divides the basic image data into first image data including a first stain area and a first non-stain area and second image data including a second stain area and a second non-stain area, and that merges the first image data and the second image data to generate merged image data including a merged stain area representing the first stain area and the second stain area and a merged non-stain area representing the first non-stain area and the second non-stain area.

### CROSS-REFERENCE TO RELATED APPLICATION(S)

This application claims priority, under 35 USC § 119, to Korean Patent Application No. 10-2023-0190511 filed on Dec. 22, 2023 in the Korean Intellectual Property Office (KIPO), the entire disclosure of which is incorporated by reference herein.

### BACKGROUND

### 1. Field

Embodiments relate to a substrate inspecting apparatus and a method of inspecting a substrate.

### 2. Description of the Related Art

During the manufacturing process of a display device, undesirable stains may be formed on a substrate. Some of the stains may be formed at the same position on different substrates. The stains formed at the same position on multiple substrates may be due to an issue in the manufacturing facilities, process conditions, or the like.

Detection of such stains on the substrate being manufactured may be performed by an automated facility, aided by observation with a naked eye. Human judgment may be involved in the substrate inspection process to avoid the quality control standard from becoming too strict because only some of the stains detected by the automated facility are visually recognizable by a user of the display device, making some stains acceptable.

### SUMMARY

Embodiments provide a substrate inspecting apparatus with improved accuracy and reliability.

Embodiments provide a method of inspecting a substrate with improved accuracy and reliability.

A substrate inspecting apparatus according to an embodiment of the present disclosure includes an image sensor that captures an image of a substrate to generate basic image data, and a merger that divides the basic image data into first image data including a first stain area and a first non-stain area and second image data including a second stain area and a second non-stain area, and that merges the first image data and the second image data to generate merged image data including a merged stain area that represents the first stain area and the second stain area and a merged non-stain area that represents the first non-stain area and the second non-stain area.

In an embodiment, the merger may determine whether the substrate is defective based on the merged image data.

In an embodiment, the merger may generate the merged image data by calculating a first normal value by normalizing a sum of a brightness of the first stain area and a brightness of the second stain area and a second normal value by normalizing a sum of a brightness of the first non-stain area and a brightness of the second non-stain area.

In an embodiment, the merger may calculate the first normal value by subtracting a predetermined value from the sum of the brightness of the first stain area and the brightness of the second stain area, and calculate the second normal value by subtracting the predetermined value from the sum of the brightness of the first non-stain area and the brightness of the second non-stain area.

In an embodiment, the merged stain area may have a same brightness as the first normal value, and the merged non-stain area may have a same brightness as the second normal value.

In an embodiment, the image sensor may include an imager that captures the image of the substrate to generate a plurality of captured image data of the substrate, an inspector that determines whether the substrate is defective based on each of the plurality of captured image data, and a generator that generates the basic image data based on the plurality of captured image data.

A method of inspecting a substrate according to an embodiment of the present disclosure includes generating basic image data by capturing an image of a substrate, dividing the basic image data into first image data including a first stain area and a first non-stain area and second image data including a second stain area and a second non-stain area, and merging the first image data and the second image data to generate merged image data including a merged stain area representing the first stain area and the second stain area and a merged non-stain area representing to the first non-stain area and the second non-stain area.

In an embodiment, the method may further include determining whether the substrate is defective based on the merged image data.

In an embodiment, the generating of the merged image data may include calculating a first normal value by normalizing a sum of a brightness of the first stain area and a brightness of the second stain area, and calculating a second normal value by normalizing a sum of a brightness of the first non-stain area and a brightness of the second non-stain area.

In an embodiment, the calculating of the first normal value and the second normal value may include subtracting a predetermined value from the sum of the brightness of the first stain area and the brightness of the second stain area, and subtracting the predetermined value from the sum of the brightness of the first non-stain area and the brightness of the second non-stain area.

In an embodiment, the merged stain area may have a same brightness as the first normal value, and the merged non-stain area may have a same brightness as the second normal value.

In an embodiment, the generating of the basic image data by capturing the image of the substrate may include generating first basic image data by capturing an image of a first substrate, and generating second basic image data by capturing an image of a second substrate.

In an embodiment, the dividing of the basic image data into the first image data and the second image data may include dividing the first basic image data into first first image data including a first first stain area and first second image data including a first second stain area, wherein the first second stain area has a position in the first second image data that is the same as the position of the first first stain area in the first first image data, and dividing the second basic image data into second first image data including a second first stain area and second second image data including a second second stain area, wherein the second second stain area has a position in the second second image data that is the same as the position of the second first stain area in the second first image data.

In an embodiment, the generating of the merged image data by merging the first image data and the second image data may include generating first merged image data including a first merged stain area representing the first first stain area and the first second stain area by merging the first first image data and the first second image data, and generating second merged image data including a second merged stain area representing the second first stain area and the second second stain area by merging the second first image data and the second second image data.

In an embodiment, the generating of the merged image data by merging the first image data and the second image data may further include generating the merged image data including the merged stain area representing the first merged stain area and the second merged stain area by merging the first merged image data and the second merged image data.

In an embodiment, the generating of the basic image data by capturing the image of the substrate may include generating first basic image data including a first first stain area and a first second stain area by capturing an image of a first substrate, and generating second basic image data including a second first stain area by capturing an image of a second substrate, wherein the second first stain area has a position in the second basic image data that is same as the position of the first first stain area in the first basic image data, and a second second stain area has a position in the second basic image data that is same as the position of the first second stain area in the second basic image data.

In an embodiment, the generating of the basic image data by capturing the image of the substrate may further include generating the basic image data including the first stain area representing the first first stain area and the second first stain area and the second stain area representing the first second stain area and the second second stain area by merging the first basic image data and the second basic image data.

In an embodiment, the generating of the basic image data may include generating a plurality of captured image data of multiple exposure areas of the substrate, and generating the basic image data through the plurality of captured image data.

In an embodiment, the generating of the basic image data may further include determining whether the substrate is defective based on each of the plurality of captured image data.

In an embodiment, the first image data may include first information about the first stain area and the first non-stain area, the second image data may include second information about the second stain area and the second non-stain area, the first information may include a position of the first stain area, a size of the first stain area, a shape of the first stain area, a brightness of the first stain area, a position of the first non-stain area, and a brightness of the first non-stain area, and the second information may include a position of the second stain area, a size of the second stain area, a shape of the second stain area, a brightness of the second stain area, a position of the second non-stain area, and a brightness of the second non-stain area.

In a substrate inspecting apparatus and a method of inspecting a substrate according to embodiments of the present disclosure, basic image data of a substrate may be divided into a plurality of image data, and the divided image data may be merged to generate merged image data. Based on the merged image data, a degree of detection of a stain repeatedly formed at a fixed position on one substrate or a plurality of substrates due to the same cause may be improved. Accordingly, since it may be more easily determined whether the substrate is defective, reliability in a manufacturing process may be improved.

### BRIEF DESCRIPTION OF THE DRAWINGS

FIG. 1 is a block diagram schematically illustrating a substrate inspecting apparatus according to an embodiment of the present disclosure.

FIG. 2 is a flowchart illustrating a method of inspecting a substrate according to an embodiment of the present disclosure.

FIGS. 3, 4, and 5 are diagrams illustrating an example of the method of inspecting the substrate of FIG. 2.

FIGS. 6, 7, 8, and 9 are diagrams illustrating another example of the method of inspecting the substrate of FIG. 2.

FIGS. 10 and 11 are diagrams illustrating still another example of the method of inspecting the substrate of FIG. 2.

### DETAILED DESCRIPTION OF THE EMBODIMENTS

Hereinafter, embodiments of the present disclosure will be described in more detail with reference to the accompanying drawings. The same reference numerals are used for the same components in the drawings, and redundant descriptions of the same components will be omitted.

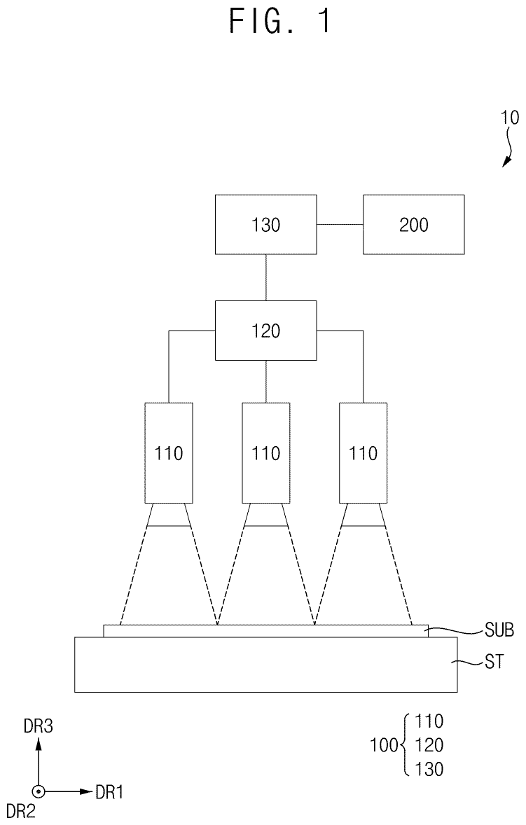

FIG. 1 is a block diagram schematically illustrating a substrate inspecting apparatus according to an embodiment of the present disclosure.

Referring to FIG. 1, a substrate inspecting apparatus 10 may include a stage ST, an image sensor 100, and a merger 200.

The substrate inspecting apparatus 10 may be used in a manufacturing process of a display device. The substrate inspecting apparatus 10 may determine a state of a substrate SUB included in the display device during the manufacturing process of the display device. For example, the substrate inspecting apparatus 10 may determine whether the substrate SUB is defective by inspecting a stain on the substrate SUB during the manufacturing process of the display device. In some embodiments, the substrate inspecting apparatus 10 may be a separate and independent apparatus, but the present disclosure is not limited thereto. In some embodiments, the substrate inspecting apparatus 10 may be disposed in an apparatus used in the manufacturing process of the display device, such as an exposure apparatus, a coating apparatus, a cutting apparatus, a cleaning apparatus, or the like.

The substrate SUB may include a transparent material or an opaque material. Examples of the material that may be used as the substrate SUB may include polyimide, quartz, glass, or the like. These may be used alone or in combination with each other.

In an embodiment, the substrate SUB may refer to a display device being manufactured. The substrate SUB may further include at least one layer included in the display device. For example, the substrate SUB may further include at least one layer of an inorganic layer, an organic layer, or a metal layer included in the display device.

The stage ST may be parallel to a plane defined by a first direction DR1 and a second direction DR2 intersecting the first direction DR1. For example, the second direction DR2 may be perpendicular to the first direction DR1. The stage ST may support the substrate SUB.

The image sensor 100 may include an imager 110, an inspector 120, and a generator 130.

The imager 110 may be spaced apart from the stage ST in a third direction DR3 intersecting each of the first direction DR1 and the second direction DR2. For example, the third direction DR3 may be perpendicular to each of the first direction DR1 and the second direction DR2. The imager 110 may capture (e.g., photograph) an image in a direction opposite to the third direction DR3. The imager 110 may capture an image of the substrate SUB. The imager 110 may generate captured image data including information about an external appearance of the substrate SUB such as a shape, a color, or the like. For example, the imager 110 may include a camera module.

There may be a plurality of imagers 110. Each of the imagers 110 may capture an image of a portion of the substrate SUB, and accordingly, a plurality of captured image data of the substrate SUB may be generated. For example, the imagers 110 may be arranged along the first direction DR1, but the present disclosure is not limited thereto. For example, the substrate SUB may move on the stage ST along the second direction DR2, and the imagers 110 may repeatedly capture images of the substrate SUB. Accordingly, the imagers 110 may capture images of the entire substrate SUB, and captured image data for the entire substrate SUB may be generated. The imager 110 may transmit the captured image data to the inspector 120.

The inspector 120 may inspect the captured image data received from the imager 110. The inspector 120 may determine whether the substrate SUB is defective through each of the captured image data. In an embodiment, the inspector 120 may detect a stain area of the captured image data to determine whether the substrate SUB is defective. That is, the inspector 120 may detect a stain on the substrate SUB to determine whether the substrate SUB is defective.

The generator 130 may generate basic image data corresponding to the images of the entire substrate SUB through the captured image data generated by the imager 110. The generator 130 may transmit the basic image data to the merger 200.

In an embodiment, the merger 200 may divide the basic image data to generate a plurality of image data. Each of the image data may be an image of an area exposed with one mask in an exposure process during the manufacturing process of the display device. That is, the substrate SUB may include a plurality of exposure areas, and the exposure areas may be exposed sequentially by moving the position of the same mask or the substrate SUB.

As the exposure areas of the substrate SUB may each be exposed using the same mask, the image data may be substantially similar to each other. For example, if a foreign substance, a defect, or the like occurs in the mask used in the exposure process, each of the image data may include a stain formed at the same position. However, the present disclosure is not limited thereto. Due to various causes such as an apparatus used in the manufacturing process of the display device, a condition of the manufacturing process of the display device, or the like, each of the image data may include a stain formed at a fixed position due to the same cause.

In an embodiment, the merger 200 may merge the plurality of image data to generate merged image data.

In an embodiment, the merger 200 may inspect the merged image data. The merger 200 may determine whether the substrate SUB is defective through the merged image data. In an embodiment, the merger 200 may detect a merged stain area of the merged image data to determine whether the substrate SUB is defective. That is, the merger 200 may detect a stain on the substrate SUB to determine whether the substrate SUB is defective.

In this case, since the merger 200 may determine whether the substrate SUB is defective based on the merged image data, it may also be possible to detect a stain that is not detected in the non-merged image data (e.g., the captured image data, the image data, or the like.). In other words, a degree of detection of a stain that occurs fixedly at the same position on the substrate SUB may be improved by the merger 200.

Although FIG. 1 illustrates each of the imager 110, the inspector 120, the generator 130, and the merger 200 as a separate piece in the substrate inspecting apparatus 10, the present disclosure is not limited thereto. For example, the imager 110, the inspector 120, the generator 130, and the merger 200 may be implemented as one, two, or three separate pieces.

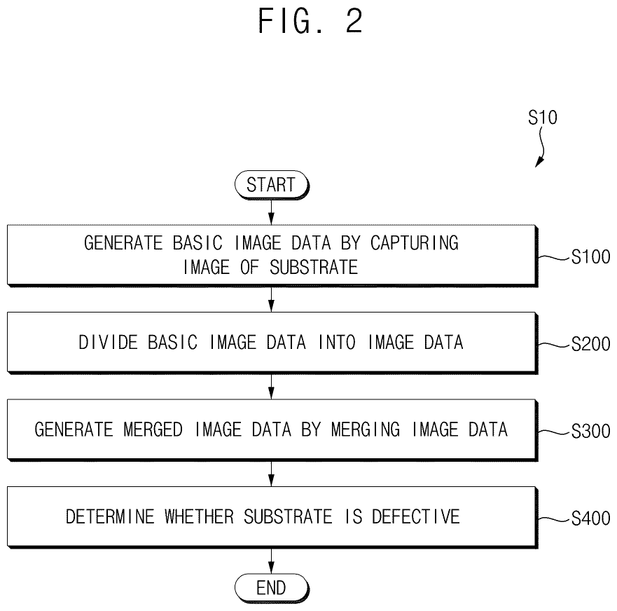

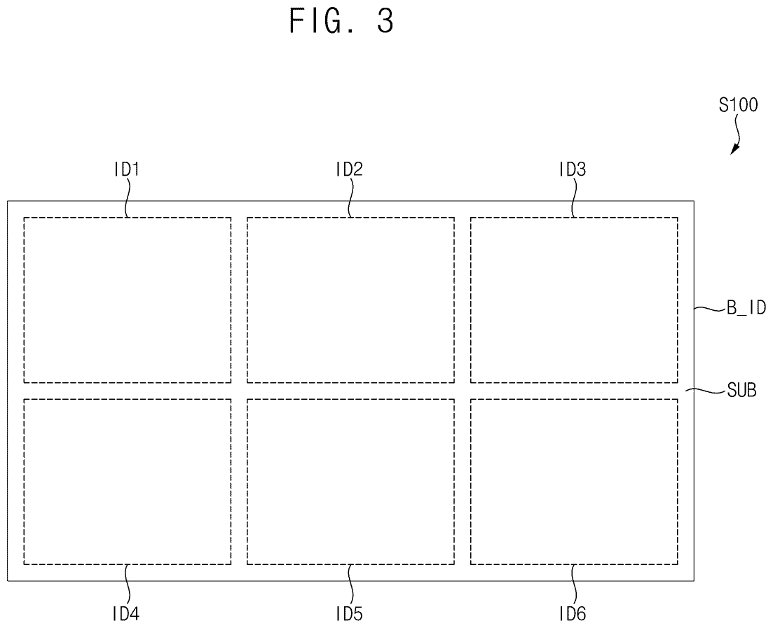

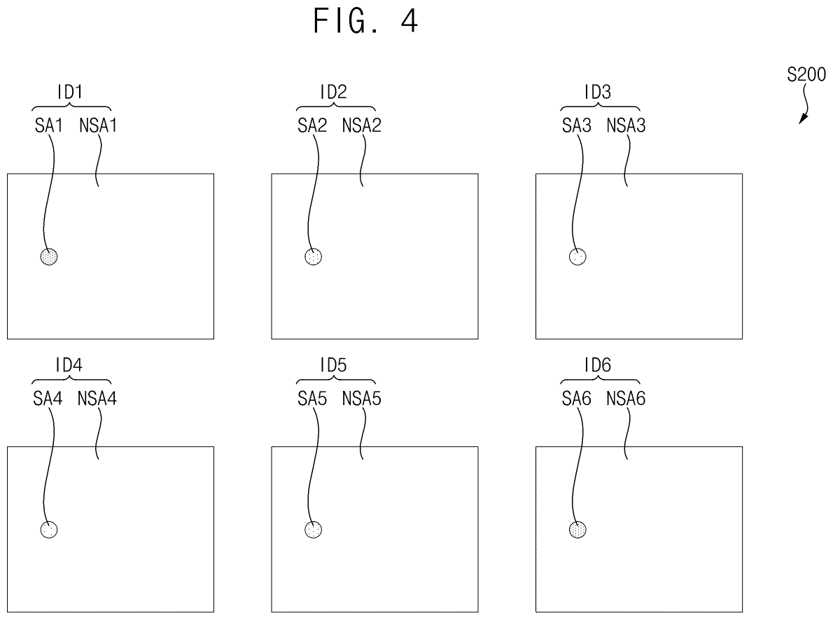

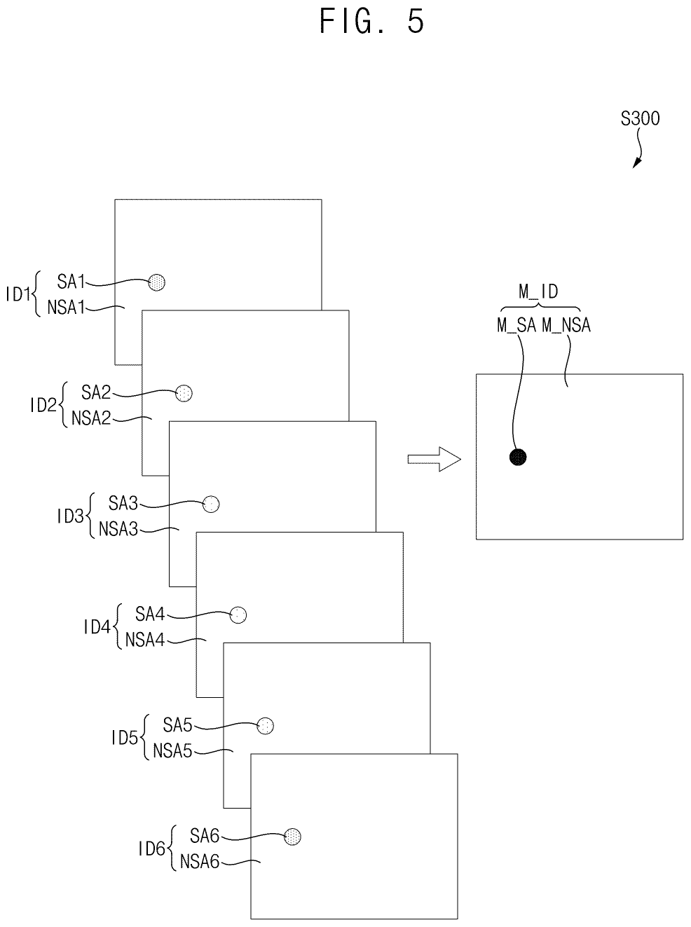

FIG. 2 is a flowchart illustrating a method of inspecting a substrate according to an embodiment of the present disclosure. FIGS. 3, 4, and 5 are diagrams illustrating an example of the method of inspecting the substrate of FIG. 2.

A method (S10) of inspecting a substrate described with reference to FIGS. 2, 3, 4, and 5 may be performed by the substrate inspecting apparatus 10 described with reference to FIG. 1. Hereinafter, redundant descriptions will be omitted or simplified.

Referring to FIGS. 1, 2, and 3, in the method (S10) of inspecting the substrate, the image sensor 100 may generate basic image data B_ID by capturing an image of the substrate SUB (e.g., by photographing the substrate SUB) (S100). For example, the imager 110 may generate captured image data by capturing the image of the substrate SUB, and the generator 130 may generate the basic image data B_ID based on the captured image data. The basic image data B_ID may be transmitted from the image sensor 100 to the merger 200.

The basic image data B_ID may include a plurality of image data. For example, the basic image data B_ID may include first image data ID1, second image data ID2, third image data ID3, fourth image data ID4, fifth image data ID5, and sixth image data ID6.

The first, second, third, fourth, fifth, and sixth image data ID1, ID2, ID3, ID4, ID5, and ID6 may correspond to exposure areas in which the substrate SUB is exposed using a mask, respectively. For example, the exposure areas of the substrate SUB may be sequentially exposed as the first, second, third, fourth, fifth, and sixth image data ID1, ID2, ID3, ID4, ID5, and ID6. However, the present disclosure is not limited thereto, and the order in which the exposure areas of the substrate SUB are exposed corresponding to the first, second, third, fourth, fifth, and sixth image data ID1, ID2, ID3, ID4, ID5, and ID6 may be variously changed.

Referring to FIGS. 1, 2, 3, and 4, in the method (S10) of inspecting the substrate, the merger 200 may divide the basic image data B_ID into the first, second, third, fourth, fifth, and sixth image data ID1, ID2, ID3, ID4, ID5, and ID6 (S200) based on the exposure areas and/or based on stain patterns. Although six image data are used to illustrate the concept, this is not a limitation of the disclosure.

Each of the first, second, third, fourth, fifth, and sixth image data ID1, ID2, ID3, ID4, ID5, and ID6 may include a stain area and a non-stain area. The stain area may be an area in which a stain is positioned on the substrate SUB, and the non-stain area may be an area in which a stain is not positioned on the substrate SUB.

For example, the first image data ID1 may include a first stain area SA1 and a first non-stain area NSA1, and the second image data ID2 may include a second stain area SA2 and a second non-stain area NSA2. The third image data ID3 may include a third stain area SA3 and a third non-stain area NSA3, and the fourth image data ID4 may include a fourth stain area SA4 and a fourth non-stain area NSA4. The fifth image data ID5 may include a fifth stain area SA5 and a fifth non-stain area NSA5, and the sixth image data ID6 may include a sixth stain area SA6 and a sixth non-stain area NSA6.

The first image data ID1 may include first information about the first stain area SA1 and the first non-stain area NSA1. For example, the first information may include position, size, shape, and brightness of the first stain area SA1, and position, size, shape, and brightness of the first non-stain area NSA1.

The second image data ID2 may include second information about the second stain area SA2 and the second non-stain area NSA2. For example, the second information may include position, size, shape, and brightness of the second stain area SA2, and position, size, shape, and brightness of the second non-stain area NSA2.

The third image data ID3 may include third information about the third stain area SA3 and the third non-stain area NSA3. For example, the third information may include position, size, shape, and brightness of the third stain area SA3, and position, size, shape, and brightness of the third non-stain area NSA3.

The fourth image data ID4 may include fourth information about the fourth stain area SA4 and the fourth non-stain area NSA4. For example, the fourth information may include position, size, shape, and brightness of the fourth stain area SA4, and position, size, shape, and brightness of the fourth non-stain area NSA4.

The fifth image data ID5 may include fifth information about the fifth stain area SA5 and the fifth non-stain area NSA5. For example, the fifth information may include position, size, shape, and brightness of the fifth stain area SA5, and position, size, shape, and brightness of the fifth non-stain area NSA5.

The sixth image data ID6 may include sixth information about the sixth stain area SA6 and the sixth non-stain area NSA6. For example, the sixth information may include position, size, shape, and brightness of the sixth stain area SA6, and position, size, shape, and brightness of the sixth non-stain area NSA6.

In an embodiment, the first, second, third, fourth, fifth, and sixth stain areas SA1, SA2, SA3, SA4, SA5, and SA6 may generally be in the same position within each of the first, second, third, fourth, fifth, and sixth image data ID1, ID2, ID3, ID4, ID5, and ID6, respectively. The first, second, third, fourth, fifth, and sixth non-stain areas NSA1, NSA2, NSA3, NSA4, NSA5, and NSA6 may generally refer to the same areas within each of the first, second, third, fourth, fifth, and sixth image data ID1, ID2, ID3, ID4, ID5, and ID6, respectively.

For example, in the first, second, third, fourth, fifth, and sixth image data ID1, ID2, ID3, ID4, ID5, and ID6, the positions of the first, second, third, fourth, fifth, and sixth stain areas SA1, SA2, SA3, SA4, SA5, and SA6 may be substantially the same, and the positions of the first, second, third, fourth, fifth, and sixth non-stain areas NSA1, NSA2, NSA3, NSA4, NSA5, and NSA6 may be substantially the same. The sizes of the first, second, third, fourth, fifth, and sixth stain areas SA1, SA2, SA3, SA4, SA5, and SA6 may be substantially the same, and the sizes of the first, second, third, fourth, fifth, and sixth non-stain areas NSA1, NSA2, NSA3, NSA4, NSA5, and NSA6 may be substantially the same. The shapes of the first, second, third, fourth, fifth, and sixth stain areas SA1, SA2, SA3, SA3, SA4, SA5, and SA6 may be substantially the same, and the shapes of the first, second, third, fourth, fifth, and sixth non-stain areas NSA1, NSA2, NSA3, NSA4, NSA5, and NSA6 may be substantially the same.

However, the brightness of the first, second, third, fourth, fifth, and sixth stain areas SA1, SA2, SA3, SA4, SA5, and SA6 may not be substantially the same, and the brightness of the first, second, third, fourth, fifth, and sixth non-stain areas NSA1, NSA2, NSA3, NSA4, NSA5, and NSA6 may not be substantially the same.

Referring to FIGS. 1, 2, 3, 4, and 5, in the method (S10) of inspecting the substrate, the merger 200 may generate merged image data M_ID by merging the first, second, third, fourth, fifth, and sixth image data ID1, ID2, ID3, ID4, ID5, and ID6 (S300). For example, the merged image data M_ID may be generated using the first, second, third, fourth, fifth, and sixth information respectively included in the first, second, third, fourth, fifth, and sixth image data ID1, ID2, ID3, ID4, ID5, and ID6.

The merged image data M_ID may include a merged stain area M_SA and a merged non-stain area M_NSA. The merged image data M_ID may include merged information about the merged stain area M_SA and the merged non-stain area M_NSA. For example, the merged information may include position, size, shape, and brightness of the merged stain area M_SA, and position, size, shape, and brightness of the merged non-stain area M_NSA.

In an embodiment, the merged stain area M_SA may represent the first, second, third, fourth, fifth, and sixth stain areas SA1, SA2, SA3, SA4, SA5, and SA6, and the merged non-stain area M_NSA may represent the first, second, third, fourth, fifth, and sixth non-stain areas NSA1, NSA2, NSA3, NSA4, NSA5, and NSA6. The “representation” indicates a merged value of position, size, shape, and brightness of the constituents.

For example, the position of the merged stain area M_SA in the merged image data M_ID may be substantially the same as the positions of the first, second, third, fourth, fifth, and sixth stain areas SA1, SA2, SA3, SA4, SA5, and SA6 in the first, second, third, fourth, fifth, and sixth image data ID1, ID2, ID3, ID4, ID5, and ID6. The position of the merged non-stain area M_NSA in the merged image data M_ID may be substantially the same as the positions of the first, second, third, fourth, fifth, and sixth non-stain areas NSA1, NSA2, NSA3, NSA4, NSA5, and NSA6 in the first, second, third, fourth, fifth, and sixth image data ID1, ID2, ID3, ID4, ID5, and ID6.

The size of the merged stain area M_SA may be substantially the same as the sizes of the first, second, third, fourth, fifth, and sixth stain areas SA1, SA2, SA3, SA4, SA5, and SA6, and the size of the merged non-stain area M_NSA may be substantially the same as the sizes of the first, second, third, fourth, fifth, and sixth non-stain areas NSA1, NSA2, NSA3, NSA4, NSA5, and NSA6. The shape of the merged stain area M_SA may be substantially the same as the shapes of the first, second, third, fourth, fifth, and sixth stain areas SA1, SA2, SA3, SA4, SA5, and SA6, and the shape of the merged non-stain area M_NSA may be substantially the same as the shapes of the first, second, third, fourth, fifth, and sixth non-stain areas NSA1, NSA2, NSA3, NSA4, NSA5, and NSA6.

However, the brightness of the merged stain area M_SA may not be substantially the same as the brightness of the first, second, third, fourth, fifth, and sixth stain areas SA1, SA2, SA3, SA4, SA5, and SA6, and the brightness of the merged non-stain area M_NSA may not be substantially the same as the brightness of the first, second, third, fourth, fifth, and sixth non-stain areas NSA1, NSA2, NSA3, NSA4, NSA5, and NSA6.

In an embodiment, the merger 200 may calculate a first normal value and a second normal value. The first normal value may be a value obtained by normalizing a sum of the brightness of each of the first, second, third, fourth, fifth, and sixth stain areas SA1, SA2, SA3, SA4, SA5, and SA6, and the second normal value may be a value obtained by normalizing a sum of the brightness of each of the first, second, third, fourth, fifth, and sixth non-stain areas NSA1, NSA2, NSA3, NSA4, NSA5, and NSA6.

In this case, the merger 200 may calculate the first normal value and the second normal value so that an average value of the first normal value and the second normal value may be equal to an average value of brightness of each of the first, second, third, fourth, fifth, and sixth image data ID1, ID2, ID3, ID4, ID5, and ID6. For example, the merger 200 may calculate the first normal value by subtracting a predetermined value (e.g., the average value of the brightness of each of the first, second, third, fourth, fifth, and sixth image data ID1, ID2, ID3, ID4, ID5, and ID6) from the sum of the brightness of each of the first, second, third, fourth, fifth, and sixth stain areas SA1, SA2, SA3, SA4, SA5, and SA6. The merger 200 may calculate the second normal value by subtracting the same predetermined value from the sum of the brightness of each of the first, second, third, fourth, fifth, and sixth non-stain areas NSA1, NSA2, NSA3, NSA4, NSA5, and NSA6.

In an embodiment, the brightness of the merged stain area M_SA may be the same as the first normal value, and the brightness of the merged non-stain area M_NSA may be the same as the second normal value. Accordingly, a difference between the brightness of the merged stain area M_SA and the brightness of the merged non-stain area M_NSA may be greater than all six differences between each individual brightness of the first, second, third, fourth, fifth, and sixth stain areas SA1, SA2, SA3, SA4, SA5, and SA6 and the individual brightness of the first, second, third, fourth, fifth, and sixth non-stain areas NSA1, NSA2, NSA3, NSA4, NSA5, and NSA6, respectively.

If each of the six difference values between the brightness of the first, second, third, fourth, fifth, and sixth stain areas SA1, SA2, SA3, SA4, SA5, and SA6 and the brightness of the first, second, third, fourth, fifth, and sixth non-stain areas NSA1, NSA2, NSA3, NSA4, NSA5, and NSA6, respectively, is relatively small, a stain may go undetected by the first, second, third, fourth, fifth, and sixth image data ID1, ID2, ID3, ID4, ID5, and ID6.

In an embodiment, since the difference between the brightness of the merged stain area M_SA and the brightness of the merged non-stain area M_NSA may be large compared to the difference between the brightness levels of a single, un-merged stain area and non-stain area, a stain formed at substantially the same position on the substrate SUB may be detected by the merged image data M_ID even if it avoided detection in each of the first, second, third, fourth, fifth, and sixth image data ID1, ID2, ID3, ID4, ID5, and ID6. Accordingly, detection of a stain formed at a fixed position on the substrate SUB due to the same cause (e.g., foreign substance or defect in a mask, or the like) may improve in accuracy.

In the method (S10) of inspecting the substrate, it may be determined whether the substrate SUB is defective based on the merged image data M_ID (S400).

In an embodiment, the merger 200 may determine whether the substrate SUB is defective based on the merged image data M_ID.

In another embodiment, the merged image data M_ID may be provided to a user, and the user may determine whether the substrate SUB is defective based on the merged image data M_ID.

Although FIGS. 3, 4, and 5 illustrate that the basic image data B_ID includes six image data ID1, ID2, ID3, ID4, ID5, and ID6, the present disclosure is not limited thereto. For example, the basic image data B_ID may include five or less or seven or more image data, and the number of the image data may be variously changed depending on a size of the substrate SUB, a mask used in the exposure process, an exposure capability, or the like. In other words, the substrate SUB may include one or more exposure areas.

In the method (S10) of inspecting the substrate according to an embodiment of the present disclosure, the substrate inspecting apparatus 10 may generate the merged image data M_ID by merging the image data ID1, ID2, ID3, ID4, ID5, and ID6 obtained by dividing the basic image data B_ID of the substrate SUB. Based on the merged image data M_ID, detection of a stain repeatedly formed at a fixed position on the substrate SUB due to the same cause (e.g., foreign substance or defect in a mask, or the like) may improve in accuracy. Accordingly, since it may be more easily determined whether the substrate SUB is defective, reliability in the manufacturing process may improve.

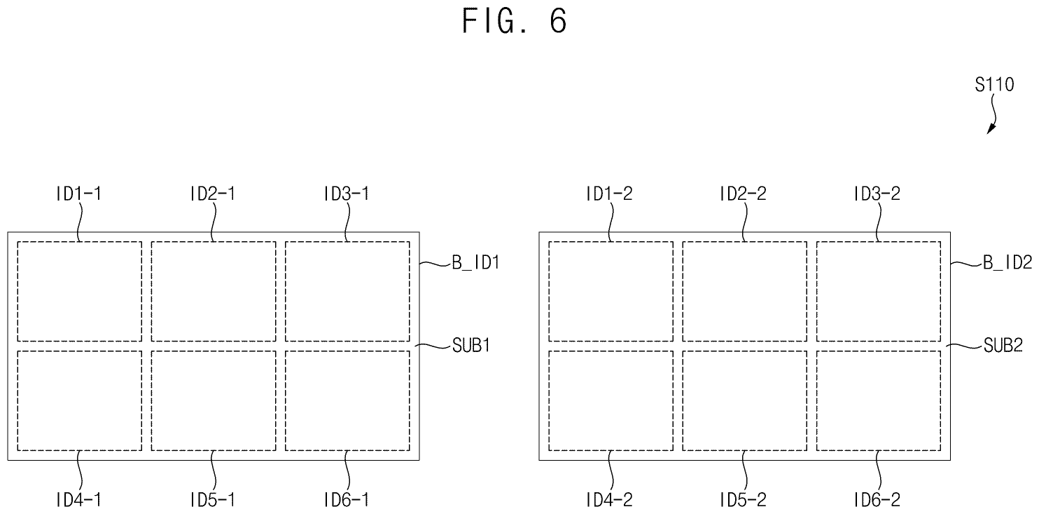

FIGS. 6, 7, 8, and 9 are diagrams illustrating another example of the method of inspecting the substrate of FIG. 2.

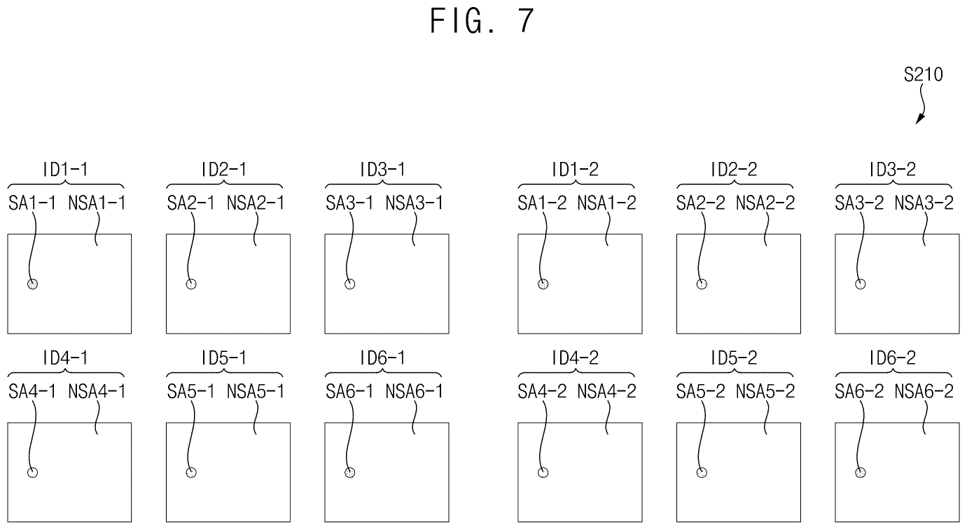

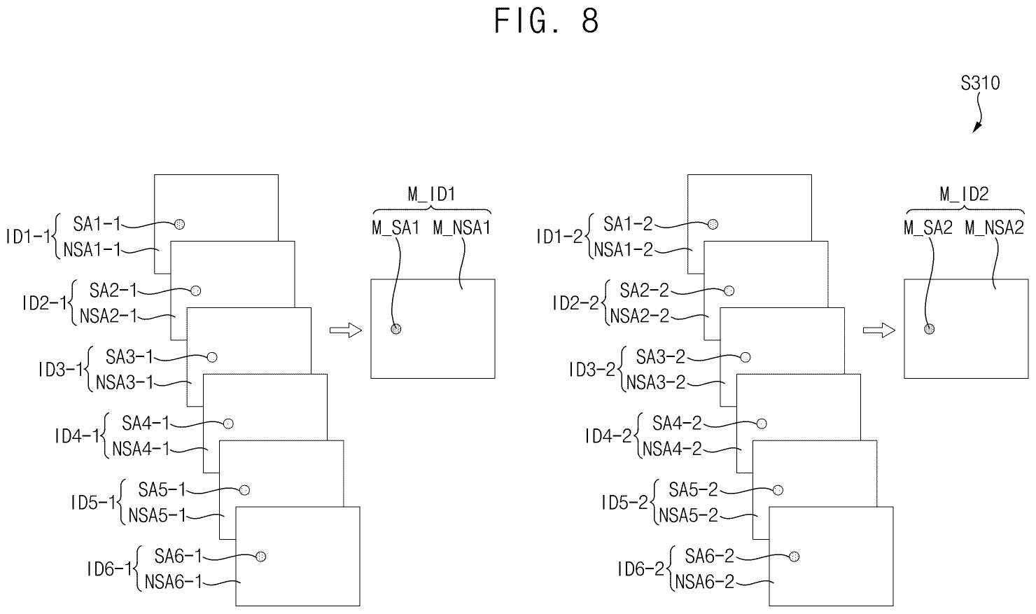

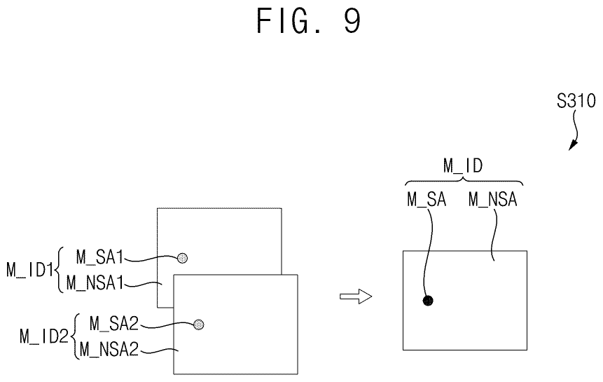

For example, FIG. 6 may correspond to the step (S100) of generating the basic image data B_ID in the method (S10) of inspecting the substrate, FIG. 7 may correspond to the step (S200) of dividing the basic image data B_ID in the method (S10) of inspecting the substrate, and FIGS. 8 and 9 may correspond to the step (S300) of generating the merged image data M_ID in the method (S10) of inspecting the substrate.

Hereinafter, any redundant descriptions of the substrate inspecting apparatus 10 described with reference to FIG. 1 and the method (S10) described with reference to FIGS. 2, 3, 4, and 5 will be omitted or abbreviated.

Referring to FIGS. 1, 2, and 6, in the method (S10) of inspecting the substrate, the image sensor 100 may generate first basic image data B_ID1 by capturing an image of a first substrate SUB1, and may generate second basic image data B_ID2 by capturing an image of a second substrate SUB2 (S110).

In an embodiment, each of the first substrate SUB1 and the second substrate SUB2 may refer to a display device being manufactured. The first substrate SUB1 and the second substrate SUB2 may be display devices being manufactured through the same manufacturing process. Each of the first substrate SUB1 and the second substrate SUB2 may correspond to the substrate SUB of FIG. 1.

For example, the imager 110 may generate first captured image data and second captured image data by capturing images of the first substrate SUB1 and the second substrate SUB2, respectively, and the generator 130 may generate the first basic image data B_ID1 and the second basic image data B_ID2 through the first captured image data and the second captured image data, respectively. Each of the first basic image data B_ID1 and the second basic image data B_ID2 may be transmitted from the image sensor 100 to the merger 200.

Each of the first basic image data B_ID1 and the second basic image data B_ID2 may include a plurality of smaller image data. For example, the first basic image data B_ID1 may include first first image data ID1-1 (hereinafter, will be referred to as “(1-1)th image data”), first second image data ID2-1 (hereinafter, will be referred to as “(2-1)th image data”), first third image data ID3-1 (hereinafter, will be referred to as “(3-1)th image data”), first fourth image data ID4-1 (hereinafter, will be referred to as “(4-1)th image data”), first fifth image data ID5-1 (hereinafter, will be referred to as “(5-1)th image data”), and first sixth image data ID6-1 (hereinafter, will be referred to as “(6-1)th image data”). The second basic image data B_ID2 may include second first image data ID1-2 (hereinafter, will be referred to as “(1-2)th image data”), second second image data ID2-2 (hereinafter, will be referred to as “(2-2)th image data”), second third image data ID3-2 (hereinafter, will be referred to as “(3-2)th image data”), second fourth image data ID4-2 (hereinafter, will be referred to as “(4-2)th image data”), second fifth image data ID5-2 (hereinafter, will be referred to as “(5-2)th image data”), and second sixth image data ID6-2 (hereinafter, will be referred to as “(6-2)th image data”).

Referring to FIGS. 1, 2, 6, and 7, the merger 200 may divide the first basic image data B_ID1 into the (1-1)th, (2-1)th, (3-1)th, (4-1)th, (5-1)th, and (6-1)th image data ID1-1, ID2-1, ID3-1, ID4-1, ID5-1, and ID6-1, and may divide the second basic image data B_ID2 into the (1-2)th, (2-2)th, (3-2)th, (4-2)th, (5-2)th, and (6-2)th image data ID1-2, ID2-2, ID3-2, ID4-2, ID5-2, and ID6-2 (S210).

Each of the (1-1)th, (2-1)th, (3-1)th, (4-1)th, (5-1)th, and (6-1)th image data ID1-1, ID2-1, ID3-1, ID4-1, ID5-1, and ID6-1 and the (1-2)th, (2-2)th, (3-2)th, (4-2)th, (5-2)th, and (6-2)th image data ID1-2, ID2-2, ID3-2, ID4-2, ID5-2, and ID6-2 may include a stain area and a non-stain area.

For example, the (1-1)th image data ID1-1 may include a first first stain area SA1-1 (hereinafter, will be referred to as “(1-1)th stain area”) and a first first non-stain area NSA1-1 (hereinafter, will be referred to as “(1-1)th non-stain area”). The (2-1)th image data ID2-1 may include a first second stain area SA2-1 (hereinafter, will be referred to as “(2-1)th stain area”) and a first second non-stain area NSA2-1 (hereinafter, will be referred to as “(2-1)th non-stain area”). The (3-1)th image data ID3-1 may include a first third stain area SA3-1 (hereinafter, will be referred to as “(3-1)th stain area”) and a first third non-stain area NSA3-1 (hereinafter, will be referred to as “(3-1)th non-stain area”). The (4-1)th image data ID4-1 may include a first fourth stain area SA4-1 (hereinafter, will be referred to as “(4-1)th stain area”) and a first fourth non-stain area NSA4-1 (hereinafter, will be referred to as “(4-1)th non-stain area”). The (5-1)th image data ID5-1 may include a first fifth stain area SA5-1 (hereinafter, will be referred to as “(5-1)th stain area”) and a first fifth non-stain area NSA5-1 (hereinafter, will be referred to as “(5-1)th non-stain area”). The (6-1)th image data ID6-1 may include a first sixth stain area SA6-1 (hereinafter, will be referred to as “(6-1)th stain area”) and a first sixth non-stain area NSA6-1 (hereinafter, will be referred to as “(6-1)th non-stain area”).

For example, the (1-2)th image data ID1-2 may include a second first stain area SA1-2 (hereinafter, will be referred to as “(1-2)th stain area”) and a second first non-stain area NSA1-2 (hereinafter, will be referred to as “(1-2)th non-stain area”). The (2-2)th image data ID2-2 may include a second second stain area SA2-2 (hereinafter, will be referred to as “(2-2)th stain area”) and a second second non-stain area NSA2-2 (hereinafter, will be referred to as “(2-2)th non-stain area”). The (3-2)th image data ID3-2 may include a second third stain area SA3-2 (hereinafter, will be referred to as “(3-2)th stain area”) and a second third non-stain area NSA3-2 (hereinafter, will be referred to as “(3-2)th non-stain area”). The (4-2)th image data ID4-2 may include a second fourth stain area SA4-2 (hereinafter, will be referred to as “(4-2)th stain area”) and a second fourth non-stain area NSA4-2 (hereinafter, will be referred to as “(4-2)th non-stain area”). The (5-2)th image data ID5-2 may include a second fifth stain area SA5-2 (hereinafter, will be referred to as “(5-2)th stain area”) and a second fifth non-stain area NSA5-2 (hereinafter, will be referred to as “(5-2)th non-stain area”). The (6-2)th image data ID6-2 may include a second sixth stain area SA6-2 (hereinafter, will be referred to as “(6-2)th stain area”) and a second sixth non-stain area NSA6-2 (hereinafter, will be referred to as “(6-2)th non-stain area”).

The (1-1)th, (2-1)th, (3-1)th, (4-1)th, (5-1)th, and (6-1)th image data ID1-1, ID2-1, ID3-1, ID4-1, ID5-1, and ID6-1 may include (1-1)th, (2-1)th, (3-1)th, (4-1)th, (5-1)th, and (6-1)th information about the (1-1)th, (2-1)th, (3-1)th, (4-1)th, (5-1)th, and (6-1)th stain areas SA1-1, SA2-1, SA3-1, SA4-1, SA5-1, and SA6-1 and the (1-1)th, (2-1)th, (3-1)th, (4-1)th, (5-1)th, and (6-1)th non-stain areas NSA1-1, NSA2-1, NSA3-1, NSA4-1, NSA5-1, and NSA6-1, respectively. For example, the (1-1)th, (2-1)th, (3-1)th, (4-1)th, (5-1)th, and (6-1)th information may include positions, sizes, shapes, and brightness of the (1-1)th, (2-1)th, (3-1)th, (4-1)th, (5-1)th, and (6-1)th stain areas SA1-1, SA2-1, SA3-1, SA4-1, SA5-1, and SA6-1, respectively, and may include positions, sizes, shapes, and brightness of the (1-1)th, (2-1)th, (3-1)th, (4-1)th, (5-1)th, and (6-1)th non-stain areas NSA1-1, NSA2-1, NSA3-1, NSA4-1, NSA5-1, and NSA6-1, respectively.

The (1-2)th, (2-2)th, (3-2)th, (4-2)th, (5-2)th, and (6-2)th image data ID1-2, ID2-2, ID3-2, ID4-2, ID5-2, and ID6-2 may include (1-2)th, (2-2)th, (3-2)th, (4-2)th, (5-2)th, and (6-2)th information about the (1-2)th, (2-2)th, (3-2)th, (4-2)th, (5-2)th, and (6-2)th stain areas SA1-2, SA2-2, SA3-2, SA4-2, SA5-2, and SA6-2 and the (1-2)th, (2-2)th, (3-2)th, (4-2)th, (5-2)th, and (6-2)th non-stain areas NSA1-2, NSA2-2, NSA3-2, NSA4-2, NSA5-2, and NSA6-2, respectively. For example, the (1-2)th, (2-2)th, (3-2)th, (4-2)th, (5-2)th, and (6-2)th information may include positions, sizes, shapes, and brightness of the (1-2)th, (2-2)th, (3-2)th, (4-2)th, (5-2)th, and (6-2)th stain areas SA1-2, SA2-2, SA3-2, SA4-2, SA5-2, and SA6-2, respectively, and may include positions, sizes, shapes, and brightness of the (1-2)th, (2-2)th, (3-2)th, (4-2)th, (5-2)th, and (6-2)th non-stain areas NSA1-2, NSA2-2, NSA3-2, NSA4-2, NSA5-2, and NSA6-2, respectively.

In an embodiment, the (1-1)th, (2-1)th, (3-1)th, (4-1)th, (5-1)th, and (6-1)th stain areas SA1-1, SA2-1, SA3-1, SA4-1, SA5-1, and SA6-1 and the (1-2)th, (2-2)th, (3-2)th, (4-2)th, (5-2)th, and (6-2)th stain areas SA1-2, SA2-2, SA3-2, SA4-2, SA5-2, and SA6-2 may have the same position in their respective un-merged image data, and the (1-1)th, (2-1)th, (3-1)th, (4-1)th, (5-1)th, and (6-1)th non-stain areas NSA1-1, NSA2-1, NSA3-1, NSA4-1, NSA5-1 and NSA6-1 and the (1-2)th, (2-2)th, (3-2)th, (4-2)th, (5-2)th, and (6-2)th non-stain areas NSA1-2, NSA2-2, NSA3-2, NSA4-2, NSA5-2, and NSA6-2 may have the same position in their respective un-merged image data.

For example, the positions of the (1-1)th, (2-1)th, (3-1)th, (4-1)th, (5-1)th, and (6-1)th stain areas SA1-1, SA2-1, SA3-1, SA4-1, SA5-1, and SA6-1 in the (1-1)th, (2-1)th, (3-1)th, (4-1)th, (5-1)th, and (6-1)th image data ID1-1, ID2-1, ID3-1, ID4-1, ID5-1, and ID6-1 and the positions of the (1-2)th, (2-2)th, (3-2)th, (4-2)th, (5-2)th, and (6-2)th stain areas SA1-2, SA2-2, SA3-2, SA4-2, SA5-2, and SA6-2 in the (1-2)th, (2-2)th, (3-2)th, (4-2)th, (5-2)th, and (6-2)th image data ID1-2, ID2-2, ID3-2, ID4-2, ID5-2, and ID6-2 may be substantially the same. The positions of the (1-1)th, (2-1)th, (3-1)th, (4-1)th, (5-1)th, and (6-1)th non-stain areas NSA1-1, NSA2-1, NSA3-1, NSA4-1, NSA5-1, and NSA6-1 in the (1-1)th, (2-1)th, (3-1)th, (4-1)th, (5-1)th, and (6-1)th image data ID1-1, ID2-1, ID3-1, ID4-1, ID5-1, and ID6-1 and the positions of the (1-2)th, (2-2)th, (3-2)th, (4-2)th, (5-2)th, and (6-2)th non-stain areas NSA1-2, NSA2-2, NSA3-2, NSA4-2, NSA5-2, and NSA6-2 in the (1-2)th, (2-2)th, (3-2)th, (4-2)th, (5-2)th, and (6-2)th image data ID1-2, ID2-2, ID3-2, ID4-2, ID5-2, and ID6-2 may be substantially the same.

The sizes and shapes of the (1-1)th, (2-1)th, (3-1)th, (4-1)th, (5-1)th, and (6-1)th stain areas SA1-1, SA2-1, SA3-1, SA4-1, SA5-1, and SA6-1 may be substantially the same as the sizes and shapes of the (1-2)th, (2-2)th, (3-2)th, (4-2)th, (5-2)th, and (6-2)th stain areas SA1-2, SA2-2, SA3-2, SA4-2, SA5-2, and SA6-2, respectively. The sizes and shapes of the (1-1)th, (2-1)th, (3-1)th, (4-1)th, (5-1)th, and (6-1)th non-stain areas NSA1-1, NSA2-1, NSA3-1, NSA4-1, NSA5-1 and NSA6-1 may be substantially the same as the sizes and shapes of the (1-2)th, (2-2)th, (3-2)th, (4-2)th, (5-2)th, and (6-2)th non-stain areas NSA1-2, NSA2-2, NSA3-2, NSA4-2, NSA5-2, and NSA6-2, respectively.

However, the brightness of the (1-1)th, (2-1)th, (3-1)th, (4-1)th, (5-1)th, and (6-1)th stain areas SA1-1, SA2-1, SA3-1, SA4-1, SA5-1, and SA6-1 may be different from the brightness of the (1-2)th, (2-2)th, (3-2)th, (4-2)th, (5-2)th, and (6-2)th stain areas SA1-2, SA2-2, SA3-2, SA4-2, SA5-2, and SA6-2, respectively. The brightness of the (1-1)th, (2-1)th, (3-1)th, (4-1)th, (5-1)th, and (6-1)th non-stain areas NSA1-1, NSA2-1, NSA3-1, NSA4-1, NSA5-1, and NSA6-1 may be different from the brightness of the (1-2)th, (2-2)th, (3-2)th, (4-2)th, (5-2)th, and (6-2)th non-stain areas NSA1-2, NSA2-2, NSA3-2, NSA4-2, NSA5-2, and NSA6-2, respectively.

Referring to FIGS. 1, 2, 8, and 9, in the method (S10) of inspecting the substrate, the merger 200 may generate merged image data M_ID by merging the first merged image data M_ID1 and the second merged image data M_ID2. As illustrated in FIG. 8, the first merged image data M_ID1 resulted from the merging of the (1-1)th, (2-1)th, (3-1)th, (4-1)th, (5-1)th, and (6-1)th image data ID1-1, ID2-1, ID3-1, ID4-1, ID5-1, and ID6-1, and the second merged image data M_ID1 resulted from the merging of the (1-2)th, (2-2)th, (3-2)th, (4-2)th, (5-2)th, and (6-2)th image data ID1-2, ID2-2, ID3-2, ID4-2, ID5-2, and ID6-2 (S310).

The merger 200 may generate first merged image data M_ID1 by merging the (1-1)th, (2-1)th, (3-1)th, (4-1)th, (5-1)th, and (6-1)th image data ID1-1, ID2-1, ID3-1, ID4-1, ID5-1, and ID6-1. The merger 200 may generate second merged image data M_ID2 by merging the (1-2)th, (2-2)th, (3-2)th, (4-2)th, (5-2)th, and (6-2)th image data ID1-2, ID2-2, ID3-2, ID4-2, ID5-2, and ID6-2.

The first merged image data M_ID1 may include a first merged stain area M_SA1 and a first merged non-stain area M_NSA1, and the second merged image data M_ID2 may include a second merged stain area M_SA2 and a second merged non-stain area M_NSA2.

The first merged image data M_ID1 may include first merged information about the first merged stain area M_SA1 and the first merged non-stain area M_NSA1. For example, the first merged information may include position, size, shape, and brightness of the first merged stain area M_SA1, and position, size, shape, and brightness of the first merged non-stain area M_NSA1.

The second merged image data M_ID2 may include second merged information about the second merged stain area M_SA2 and the second merged non-stain area M_NSA2. For example, the second merged information may include position, size, shape, and brightness of the second merged stain area M_SA2, and position, size, shape, and brightness of the second merged non-stain area M_NSA2.

In an embodiment, the first merged stain area M_SA1 may represent the (1-1)th, (2-1)th, (3-1)th, (4-1)th, (5-1)th, and (6-1)th stain areas SA1-1, SA2-1, SA3-1, SA4-1, SA5-1, and SA6-1, and the first merged non-stain area M_NSA1 may represent the (1-1)th, (2-1)th, (3-1)th, (4-1)th, (5-1)th, and (6-1)th non-stain areas NSA1-1, NSA2-1, NSA3-1, NSA4-1, NSA5-1, and NSA6-1. The second merged stain area M_SA2 may represent the (1-2)th, (2-2)th, (3-2)th, (4-2)th, (5-2)th, and (6-2)th stain areas SA1-2, SA2-2, SA3-2, SA4-2, SA5-2, and SA6-2, and the second merged non-stain area M_NSA2 may represent the (1-2)th, (2-2)th, (3-2)th, (4-2)th, (5-2)th, and (6-2)th non-stain areas NSA1-2, NSA2-2, NSA3-2, NSA4-2, NSA5-2, and NSA6-2.

For example, the position of the first merged stain area M_SA1 in the first merged image data M_ID1 may be substantially the same as the positions of the (1-1)th, (2-1)th, (3-1)th, (4-1)th, (5-1)th, and (6-1)th stain areas SA1-1, SA2-1, SA3-1, SA4-1, SA5-1, and SA6-1 in the (1-1)th, (2-1)th, (3-1)th, (4-1)th, (5-1)th, and (6-1)th image data ID1-1, ID2-1, ID3-1, ID4-1, ID5-1, and ID6-1. The position of the first merged non-stain area M_NSA1 may be substantially the same as the positions of the (1-1)th, (2-1)th, (3-1)th, (4-1)th, (5-1)th, and (6-1)th non-stain areas NSA1-1, NSA2-1, NSA3-1, NSA4-1, NSA5-1, and NSA6-1 in the (1-1)th, (2-1)th, (3-1)th, (4-1)th, (5-1)th, and (6-1)th image data ID1-1, ID2-1, ID3-1, ID4-1, ID5-1, and ID6-1.

The size and shape of the first merged stain area M_SA1 may be substantially the same as the sizes and shapes of the (1-1)th, (2-1)th, (3-1)th, (4-1)th, (5-1)th, and (6-1)th stain areas SA1-1, SA2-1, SA3-1, SA4-1, SA5-1, and SA6-1, and the size and shape of the first merged non-stain area M_NSA1 may be substantially the same as the sizes and shapes of the (1-1)th, (2-1)th, (3-1)th, (4-1)th, (5-1)th, and (6-1)th non-stain areas NSA1-1, NSA2-1, NSA3-1, NSA4-1, NSA5-1, and NSA6-1. However, the brightness of the first merged stain area M_SA1 may not be substantially the same as the brightness of the (1-1)th, (2-1)th, (3-1)th, (4-1)th, (5-1)th, and (6-1)th stain areas SA1-1, SA2-1, SA3-1, SA4-1, SA5-1, and SA6-1, and the brightness of the first merged non-stain area M_NSA1 may not be substantially the same as the brightness of the (1-1)th, (2-1)th, (3-1)th, (4-1)th, (5-1)th, and (6-1)th non-stain areas NSA1-1, NSA2-1, NSA3-1, NSA4-1, NSA5-1, and NSA6-1.

For example, the position of the second merged stain area M_SA2 in the second merged image data M_ID2 may be substantially the same as the positions of the (1-2)th, (2-2)th, (3-2)th, (4-2)th, (5-2)th, and (6-2)th stain areas SA1-2, SA2-2, SA3-2, SA4-2, SA5-2, and SA6-2 in the (1-2)th, (2-2)th, (3-2)th, (4-2)th, (5-2)th, and (6-2)th image data ID1-2, ID2-2, ID3-2, ID4-2, ID5-2, and ID6-2. The position of the second merged non-stain area M_NSA2 in the second merged image data M_ID2 may be substantially the same as the positions of the (1-2)th, (2-2)th, (3-2)th, (4-2)th, (5-2)th, and (6-2)th non-stain areas NSA1-2, NSA2-2, NSA3-2, NSA4-2, NSA5-2, and NSA6-2 in the (1-2)th, (2-2)th, (3-2)th, (4-2)th, (5-2)th, and (6-2)th image data ID1-2, ID3-2, ID3-2, ID4-2, ID5-2, and ID6-2.

The size and shape of the second merged stain area M_SA2 may be substantially the same as the sizes and shapes of the (1-2)th, (2-2)th, (3-2)th, (4-2)th, (5-2)th, and (6-2)th stain areas SA1-2, SA2-2, SA3-2, SA4-2, SA5-2, and SA6-2, and the size and shape of the second merged non-stain area M_NSA2 may be substantially the same as the sizes and shapes of the (1-2)th, (2-2)th, (3-2)th, (4-2)th, (5-2)th, and (6-2)th non-stain areas NSA1-2, NSA2-2, NSA3-2, NSA4-2, NSA5-2, and NSA6-2. However, the brightness of the second merged stain area M_SA2 may not be substantially the same as the brightness of the (1-2)th, (2-2)th, (3-2)th, (4-2)th, (5-2)th, and (6-2)th stain areas SA1-2, SA2-2, SA3-2, SA4-2, SA5-2, and SA6-2, and the brightness of the second merged non-stain area M_NSA2 may not be substantially the same as the brightness of the (1-2)th, (2-2)th, (3-2)th, (4-2)th, (5-2)th, and (6-2)th non-stain areas NSA1-2, NSA2-2, NSA3-2, NSA4-2, NSA5-2, and NSA6-2.

Next, the merger 200 may generate the merged image data M_ID by merging the first merged image data M_ID1 and the second merged image data M_ID2. For example, the merged image data M_ID may be generated using the first and second merged information respectively included in the first and second merged image data M_ID1 and M_ID2.

The merged image data M_ID may include a merged stain area M_SA and a merged non-stain area M_NSA. The merged image data M_ID may include merged information about the merged stain area M_SA and the merged non-stain area M_NSA. For example, the merged information may include position, size, shape, and brightness of the merged stain area M_SA, and position, size, shape, and brightness of the merged non-stain area M_NSA.

In an embodiment, the merged stain area M_SA may correspond to the first and second merged stain areas M_SA1 and M_SA2, and the merged non-stain area M_NSA may correspond to the first and second merged non-stain areas M_NSA1 and M_NSA2.

For example, the position of the merged stain area M_SA in the merged image data M_ID may be substantially the same as the positions of the first and second merged stain areas M_SA1 and M_SA2 in the first and second merged image data M_ID1 and M_ID2, and the position of the merged non-stain area M_NSA in the merged image data M_ID may be substantially the same as the positions of the first and second merged non-stain areas M_NSA1 and M_NSA2 in the first and second merged image data M_ID1 and M_ID2.

The size and shape of the merged stain area M_SA may be substantially the same as the sizes and shapes of the first and second merged stain areas M_SA1 and M_SA2, and the size and shape of the merged non-stain area M_NSA may be substantially the same as the sizes and shapes of the first and second merged non-stain areas M_NSA1 and M_NSA2. However, the brightness of the merged stain area M_SA may not be substantially the same as the brightness of the first and second merged stain areas M_SA1 and M_SA2, and the brightness of the merged non-stain area M_NSA may not be substantially the same as the brightness of the first and second merged non-stain areas M_NSA1 and M_NSA2.

In an embodiment, a difference between the brightness of the merged stain area M_SA and the brightness of the merged non-stain area M_NSA may be greater than the differences between each of the brightness of the (1-1)th, (2-1)th, (3-1)th, (4-1)th, (5-1)th, and (6-1)th stain areas SA1-1, SA2-1, SA3-1, SA4-1, SA5-1, and SA6-1 and the brightness of the (1-1)th, (2-1)th, (3-1)th, (4-1)th, (5-1)th, and (6-1)th non-stain areas NSA1-1, NSA2-1, NSA3-1, NSA4-1, NSA5-1, and NSA6-1, respectively, and may be greater than the differences between each of the brightness of the (1-2)th, (2-2)th, (3-2)th, (4-2)th, (5-2)th, and (6-2)th stain areas SA1-2, SA2-2, SA3-2, SA4-2, SA5-2, and SA6-2 and the brightness of the (1-2)th, (2-2)th, (3-2)th, (4-2)th, (5-2)th, and (6-2)th non-stain areas NSA1-2, NSA2-2, NSA3-2, NSA4-2, NSA5-2, and NSA6-2, respectively.

Therefore, a stain formed at substantially the same position on the first substrate SUB1 and the second substrate SUB2 may be detected by the merged image data M_ID even if it is not detected individually in the (1-1)th, (2-1)th, (3-1)th, (4-1)th, (5-1)th, and (6-1)th image data ID1-1, ID2-1, ID3-1, ID4-1, ID5-1, and ID6-1 and the (1-2)th, (2-2)th, (3-2)th, (4-2)th, (5-2)th, and (6-2)th image data ID1-2, ID2-2, ID3-2, ID4-2, ID5-2, and ID6-2. Accordingly, the accuracy of detection of a stain formed at a fixed position on a plurality of substrates (e.g., the first substrate SUB1 and the second substrate SUB2) due to the same cause may be improved.

In the method (S10) of inspecting the substrate according to an embodiment of the present disclosure, the substrate inspecting apparatus 10 may generate the merged image data M_ID by merging the image data ID1-1, ID2-1, ID3-1, ID4-1, ID5-1, ID6-1, ID1-2, ID2-2, ID3-2, ID4-2, ID5-2, and ID6-2 obtained by dividing the basic image data B_ID1 and B_ID2 of the substrates SUB1 and SUB2. Based on the merged image data M_ID, the accuracy of detection of a stain repeatedly formed at a fixed position on the substrates SUB1 and SUB2 due to the same cause (e.g., foreign substance or defect in a mask, or the like) may be improved. Accordingly, since it may be more easily determined whether the substrates SUB1 and SUB2 are defective, reliability in the manufacturing process may be improved.

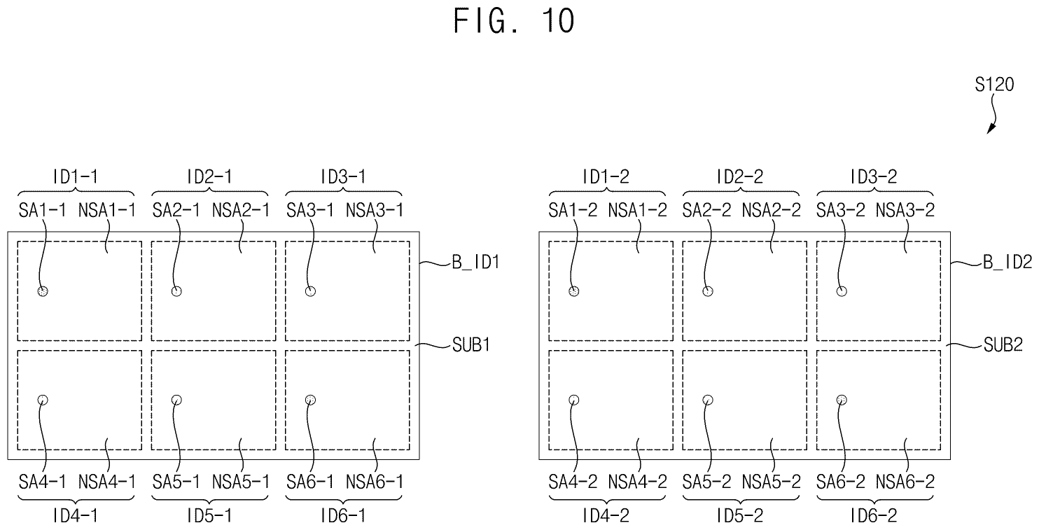

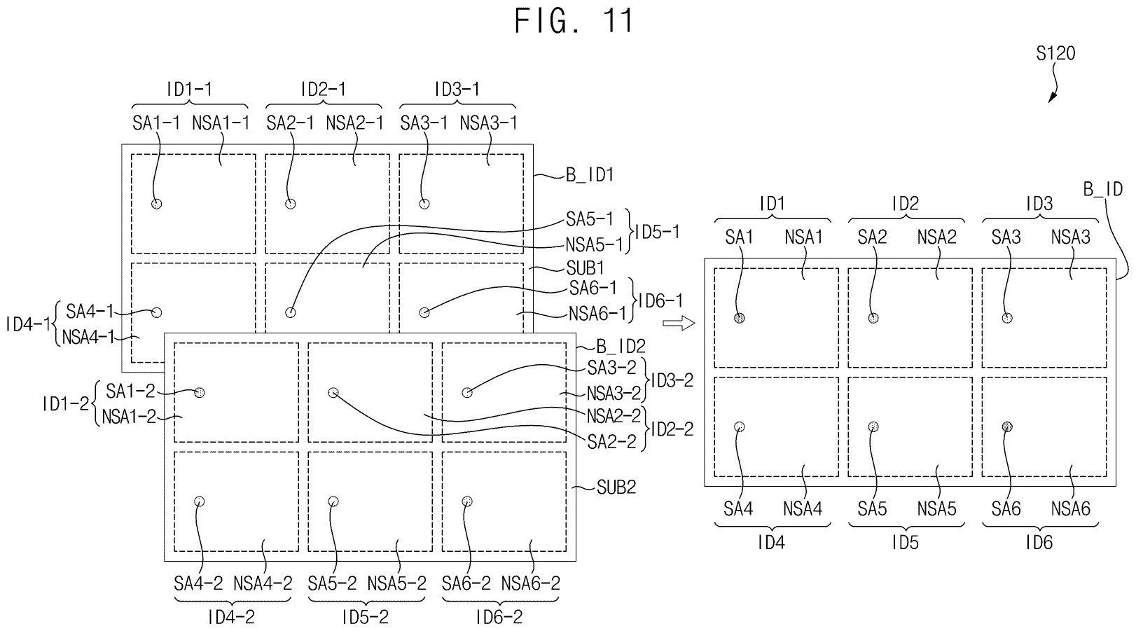

FIGS. 10 and 11 are diagrams illustrating another example of the method of inspecting the substrate of FIG. 2.

For example, FIGS. 10 and 11 may correspond to the step (S100) of generating the basic image data B_ID in the method (S10) of inspecting the substrate.

Hereinafter, any redundant descriptions that were presented above for the substrate inspecting apparatus 10 in reference to FIG. 1 and the method (S10) described with reference to FIGS. 2, 3, 4, 5, 6, 7, 8, and 9 will be omitted or abbreviated.

Referring to FIGS. 1, 2, 10, and 11, in the method (S10) of inspecting the substrate, the image sensor 100 may generate basic image data B_ID by capturing images of a first substrate SUB1 and a second substrate SUB2 (S120).

First, the image sensor 100 may generate first basic image data B_ID1 by capturing the image of the first substrate SUB1, and may generate second basic image data B_ID2 by capturing the image of the second substrate SUB2. Each of the first substrate SUB1 and the second substrate SUB2 may be the substrate SUB of FIG. 1.

For example, the imager 110 may generate first captured image data and second captured image data by capturing the images of the first substrate SUB1 and the second substrate SUB2, respectively. The generator 130 may generate the first basic image data B_ID1 and the second basic image data B_ID2 through the first captured image data and the second captured image data, respectively. Each of the first basic image data B_ID1 and the second basic image data B_ID2 may be transmitted from the image sensor 100 to the merger 200.

Each of the first basic image data B_ID1 and the second basic image data B_ID2 may include image data. For example, the first basic image data B_ID1 may include (1-1)th image data ID1-1, (2-1)th image data ID2-1, (3-1)th image data ID3-1, (4-1)th image data ID4-1, (5-1)th image data ID5-1, and (6-1)th image data ID6-1. The second basic image data B_ID2 may include (1-2)th image data ID1-2, (2-2)th image data ID2-2, (3-2)th image data ID3-2, (4-2)th image data ID4-2, (5-2)th image data ID5-2, and (6-2)th image data ID6-2.

Each of the (1-1)th, (2-1)th, (3-1)th, (4-1)th, (5-1)th, and (6-1)th image data ID1-1, ID2-1, ID3-1, ID4-1, ID5-1, and ID6-1 and the (1-2)th, (2-2)th, (3-2)th, (4-2)th, (5-2)th, and (6-2)th image data ID1-2, ID2-2, ID3-2, ID4-2, ID5-2, and ID6-2 may include a stain area and a non-stain area.

For example, the (1-1)th image data ID1-1 may include a (1-1)th stain area SA1-1 and a (1-1)th non-stain area NSA1-1, and the (2-1)th image data ID2-1 may include a (2-1)th stain area SA2-1 and a (2-1)th non-stain area NSA2-1. The (3-1)th image data ID3-1 may include a (3-1)th stain area SA3-1 and a (3-1)th non-stain area NSA3-1, and the (4-1)th image data ID4-1 may include a (4-1)th stain area SA4-1 and a (4-1)th non-stain area NSA4-1. The (5-1)th image data ID5-1 may include a (5-1)th stain area SA5-1 and a (5-1)th non-stain area NSA5-1, and the (6-1)th image data ID6-1 may include a (6-1)th stain area SA6-1 and a (6-1)th non-stain area NSA6-1.

For example, the (1-2)th image data ID1-2 may include a (1-2)th stain area SA1-2 and a (1-2)th non-stain area NSA1-2, and the (2-2)th image data ID2-2 may include a (2-2) stain area SA2-2 and a (2-2)th non-stain area NSA2-2. The (3-2)th image data ID3-2 may include a (3-2)th stain area SA3-2 and a (3-2)th non-stain area NSA3-2, and the (4-2)th image data ID4-2 may include a (4-2)th stain area SA4-2 and a (4-2)th non-stain area NSA4-2. The (5-2)th image data ID5-2 may include a (5-2)th stain area SA5-2 and a (5-2)th non-stain area NSA5-2, and the (6-2)th image data ID6-2 may include a (6-2)th stain area SA6-2 and a (6-2)th non-stain area NSA6-2.

The (1-1)th, (2-1)th, (3-1)th, (4-1)th, (5-1)th, and (6-1)th image data ID1-1, ID2-1, ID3-1, ID4-1, ID5-1, and ID6-1 may include (1-1)th, (2-1)th, (3-1)th, (4-1)th, (5-1)th, and (6-1)th information about the (1-1)th, (2-1)th, (3-1)th, (4-1)th, (5-1)th, and (6-1)th stain areas SA1-1, SA2-1, SA3-1, SA4-1, SA5-1, and SA6-1 and the (1-1)th, (2-1)th, (3-1)th, (4-1)th, (5-1)th, and (6-1)th non-stain areas NSA1-1, NSA2-1, NSA3-1, NSA4-1, NSA5-1, and NSA6-1, respectively. For example, the (1-1)th, (2-1)th, (3-1)th, (4-1)th, (5-1)th, and (6-1)th information may include positions, sizes, shapes, and brightness of the (1-1)th, (2-1)th, (3-1)th, (4-1)th, (5-1)th, and (6-1)th stain areas SA1-1, SA2-1, SA3-1, SA4-1, SA5-1, and SA6-1, respectively, and may include positions, sizes, shapes, and brightness of the (1-1)th, (2-1)th, (3-1)th, (4-1)th, (5-1)th, and (6-1)th non-stain areas NSA1-1, NSA2-1, NSA3-1, NSA4-1, NSA5-1, and NSA6-1, respectively.

The (1-2)th, (2-2)th, (3-2)th, (4-2)th, (5-2)th, and (6-2)th image data ID1-2, ID2-2, ID3-2, ID4-2, ID5-2, and ID6-2 may include (1-2)th, (2-2)th, (3-2)th, (4-2)th, (5-2)th, and (6-2)th information about the (1-2)th, (2-2)th, (3-2)th, (4-2)th, (5-2)th, and (6-2)th stain areas SA1-2, SA2-2, SA3-2, SA4-2, SA5-2, and SA6-2 and the (1-2)th, (2-2)th, (3-2)th, (4-2)th, (5-2)th, and (6-2)th non-stain areas NSA1-2, NSA2-2, NSA3-2, NSA4-2, NSA5-2, and NSA6-2, respectively. For example, the (1-2)th, (2-2)th, (3-2)th, (4-2)th, (5-2)th, and (6-2)th information may include positions, sizes, shapes, and brightness of the (1-2)th, (2-2)th, (3-2)th, (4-2)th, (5-2)th, and (6-2)th stain areas SA1-2, SA2-2, SA3-2, SA4-2, SA5-2, and SA6-2, respectively, and may include positions, sizes, shapes, and brightness of the (1-2)th, (2-2)th, (3-2)th, (4-2)th, (5-2)th, and (6-2)th non-stain areas NSA1-2, NSA2-2, NSA3-2, NSA4-2, NSA5-2, and NSA6-2, respectively.

In an embodiment, the (1-1)th, (2-1)th, (3-1)th, (4-1)th, (5-1)th, and (6-1)th stain areas SA1-1, SA2-1, SA3-1, SA4-1, SA5-1, and SA6-1 and the (1-2)th, (2-2)th, (3-2)th, (4-2)th, (5-2)th, and (6-2)th stain areas SA1-2, SA2-2, SA3-2, SA4-2, SA5-2, and SA6-2 may be in approximately the same position as one another within their respective image data, and the (1-1)th, (2-1)th, (3-1)th, (4-1)th, (5-1)th, and (6-1)th non-stain areas NSA1-1, NSA2-1, NSA3-1, NSA4-1, NSA5-1 and NSA6-1 and the (1-2)th, (2-2)th, (3-2)th, (4-2)th, (5-2)th, and (6-2)th non-stain areas NSA1-2, NSA2-2, NSA3-2, NSA4-2, NSA5-2, and NSA6-2 may be in approximately the same position as one another within their respective image data.

For example, the positions of the (1-1)th, (2-1)th, (3-1)th, (4-1)th, (5-1)th, and (6-1)th stain areas SA1-1, SA2-1, SA3-1, SA4-1, SA5-1, and SA6-1 in the respective (1-1)th, (2-1)th, (3-1)th, (4-1)th, (5-1)th, and (6-1)th image data ID1-1, ID2-1, ID3-1, ID4-1, ID5-1, and ID6-1 and the positions of the (1-2)th, (2-2)th, (3-2)th, (4-2)th, (5-2)th, and (6-2)th stain areas SA1-2, SA2-2, SA3-2, SA4-2, SA5-2, and SA6-2 in the respective (1-2)th, (2-2)th, (3-2)th, (4-2)th, (5-2)th, and (6-2)th image data ID1-2, ID2-2, ID3-2, ID4-2, ID5-2, and ID6-2 may be substantially the same. The positions of the (1-1)th, (2-1)th, (3-1)th, (4-1)th, (5-1)th, and (6-1)th non-stain areas NSA1-1, NSA2-1, NSA3-1, NSA4-1, NSA5-1, and NSA6-1 in the (1-1)th, (2-1)th, (3-1)th, (4-1)th, (5-1)th, and (6-1)th image data ID1-1, ID2-1, ID3-1, ID4-1, ID5-1, and ID6-1 and the positions of the (1-2)th, (2-2)th, (3-2)th, (4-2)th, (5-2)th, and (6-2)th non-stain areas NSA1-2, NSA2-2, NSA3-2, NSA4-2, NSA5-2, and NSA6-2 in the (1-2)th, (2-2)th, (3-2)th, (4-2)th, (5-2)th, and (6-2)th image data ID1-2, ID2-2, ID3-2, ID4-2, ID5-2, and ID6-2 may be substantially the same as each other.

The sizes and shapes of the (1-1)th, (2-1)th, (3-1)th, (4-1)th, (5-1)th, and (6-1)th stain areas SA1-1, SA2-1, SA3-1, SA4-1, SA5-1, and SA6-1 and the sizes and shapes of the (1-2)th, (2-2)th, (3-2)th, (4-2)th, (5-2)th, and (6-2)th stain areas SA1-2, SA2-2, SA3-2, SA4-2, SA5-2, and SA6-2 may be substantially the same, and the sizes and shapes of the (1-1)th, (2-1)th, (3-1)th, (4-1)th, (5-1)th, and (6-1)th non-stain areas NSA1-1, NSA2-1, NSA3-1, NSA4-1, NSA5-1, and NSA6-1 and the sizes and shapes of the (1-2)th, (2-2)th, (3-2)th, (4-2)th, (5-2)th, and (6-2)th non-stain areas NSA1-2, NSA2-2, NSA3-2, NSA4-2, NSA5-2, and NSA6-2 may be substantially the same.

However, the brightness of the (1-1)th, (2-1)th, (3-1)th, (4-1)th, (5-1)th, and (6-1)th stain areas SA1-1, SA2-1, SA3-1, SA4-1, SA5-1, and SA6-1 may be different from the brightness of the (1-2)th, (2-2)th, (3-2)th, (4-2)th, (5-2)th, and (6-2)th stain areas SA1-2, SA2-2, SA3-2, SA4-2, SA5-2, and SA6-2, respectively, and the brightness of the (1-1)th, (2-1)th, (3-1)th, (4-1)th, (5-1)th, and (6-1)th non-stain areas NSA1-1, NSA2-1, NSA3-1, NSA4-1, NSA5-1, and NSA6-1 may be different from the brightness of the (1-2)th, (2-2)th, (3-2)th, (4-2)th, (5-2)th, and (6-2)th non-stain areas NSA1-2, NSA2-2, NSA3-2, NSA4-2, NSA5-2, and NSA6-2, respectively.

Next, the merger 200 may generate the basic image data B_ID by merging the first basic image data B_ID1 and the second basic image data B_ID2.

The basic image data B_ID may include image data. For example, the basic image data B_ID may include first image data ID1, second image data ID2, third image data ID3, fourth image data ID4, fifth image data ID5, and sixth image data ID6.

Each of the first, second, third, fourth, fifth, and sixth image data ID1, ID2, ID3, ID4, ID5, and ID6 may include a stain area and a non-stain area. For example, the first image data ID1 may include a first stain area SA1 and a first non-stain area NSA1, and the second image data ID2 may include a second stain area SA2 and a second non-stain area NSA2. The third image data ID3 may include a third stain area SA3 and a third non-stain area NSA3, and the fourth image data ID4 may include a fourth stain area SA4 and a fourth non-stain area NSA4. The fifth image data ID5 may include a fifth stain area SA5 and a fifth non-stain area NSA5, and the sixth image data ID6 may include a sixth stain area SA6 and a sixth non-stain area NSA6.

The first, second, third, fourth, fifth, and sixth image data ID1, ID2, ID3, ID4, ID5, and ID6 may include first, second, third, fourth, fifth, and sixth information about the first, second, third, fourth, fifth, and sixth stain areas SA1, SA2, SA3, SA4, SA5, and SA6 and the first, second, third, fourth, fifth, and sixth non-stain areas NSA1, NSA2, NSA3, NSA4, NSA5, and NSA6, respectively. For example, the first, second, third, fourth, fifth, and sixth information may include positions, sizes, shapes, and brightness of the first, second, third, fourth, fifth, and sixth stain areas SA1, SA2, SA3, SA4, SA5, and SA6, respectively, and may include positions, sizes, shapes, and brightness of the first, second, third, fourth, fifth, and sixth non-stain areas NSA1, NSA2, NSA3, NSA4, NSA5, and NSA6, respectively.

In an embodiment, the first stain area SA1 may represent the (1-1)th and (1-2)th stain areas SA1-1 and SA1-2, and the first non-stain area NSA1 may represent the (1-1)th and (1-2)th non-stain areas NSA1-1 and NSA1-2. The second stain area SA2 may represent the (2-1)th and (2-2)th stain areas SA2-1 and SA2-2, and the second non-stain area NSA2 may represent the (2-1)th and (2-2)th non-stain areas NSA2-1 and NSA2-2. The third stain area SA3 may represent the (3-1)th and (3-2)th stain areas SA3-1 and SA3-2, and the third non-stain area NSA3 may represent the (3-1)th and (3-2)th non-stain areas NSA3-1 and NSA3-2. The fourth stain area SA4 may represent the (4-1)th and (4-2)th stain areas SA4-1 and SA4-2, and the fourth non-stain area NSA4 may represent the (4-1)th and (4-2)th non-stain areas NSA4-1 and NSA4-2. The fifth stain area SA5 may represent the (5-1)th and (5-2)th stain areas SA5-1 and SA5-2, and the fifth non-stain area NSA5 may represent the (5-1)th and (5-2)th non-stain areas NSA5-1 and NSA5-2. The sixth stain area SA6 may represent the (6-1)th and (6-2)th stain areas SA6-1 and SA6-2, and the sixth non-stain area NSA6 may represent the (6-1)th and (6-2)th non-stain areas NSA6-1 and NSA6-2. The “representation” indicates a merged value of position, size, shape, and brightness of the constituents.

In an embodiment, differences between the individual brightness of the first, second, third, fourth, fifth, and sixth stain areas SA1, SA2, SA3, SA4, SA5, and SA6 and the individual brightness of the first, second, third, fourth, fifth, and sixth non-stain areas NSA1, NSA2, NSA3, NSA4, NSA5, and NSA6, respectively, may be greater than the differences between the individual brightness of the (1-1)th, (2-1)th, (3-1)th, (4-1)th, (5-1)th, and (6-1)th stain areas SA1-1, SA2-1, SA3-1, SA4-1, SA5-1, and SA6-1 and the individual brightness of the (1-1)th, (2-1)th, (3-1)th, (4-1)th, (5-1)th, and (6-1)th non-stain areas NSA1-1, NSA2-1, NSA3-1, NSA4-1, NSA5-1, and NSA6-1, respectively, and may be greater than the differences between the individual brightness of the (1-2)th, (2-2)th, (3-2)th, (4-2)th, (5-2)th, and (6-2)th stain areas SA1-2, SA2-2, SA3-2, SA4-2, SA5-2, and SA6-2 and the individual brightness of the (1-2)th, (2-2)th, (3-2)th, (4-2)th, (5-2)th, and (6-2)th non-stain areas NSA1-2, NSA2-2, NSA3-2, NSA4-2, NSA5-2, and NSA6-2, respectively.

Although FIGS. 6, 7, 8, 9, 10, and 11 illustrate image data of two substrates SUB1 and SUB2 being merged, the present disclosure is not limited thereto. For example, image data of three or more substrates may be merged.

In the method (S10) of inspecting the substrate according to an embodiment of the present disclosure, the substrate inspecting apparatus 10 may generate the merged image data M_ID by merging the image data ID1, ID2, ID3, ID4, ID5, and ID6 obtained by merging and dividing the basic image data B_ID1 and B_ID2 of the plurality of substrates SUB1 and SUB2. Based on the merged image data M_ID, accuracy of detection of a stain repeatedly formed at a fixed position on the substrates SUB1 and SUB2 due to the same cause (e.g., foreign substance or defect in a mask, or the like) may be improved. Accordingly, since it may be more easily determined whether the substrates SUB1 and SUB2 are defective, reliability in the manufacturing process may be improved.

The present disclosure can be applied to a manufacturing process of various display devices. For example, the present disclosure is applicable to a manufacturing process of various display devices such as display devices for vehicles, ships and aircraft, portable communication devices, display devices for exhibition or information transmission, medical display devices, and the like.

The foregoing is illustrative of embodiments and is not to be construed as limiting thereof. Although a few embodiments have been described, those skilled in the art will readily appreciate that many modifications are possible in the embodiments without materially departing from the novel teachings and advantages of the present inventive concept. Accordingly, all such modifications are intended to be included within the scope of the present inventive concept as defined in the claims. Therefore, it is to be understood that the foregoing is illustrative of various embodiments and is not to be construed as limited to the specific embodiments disclosed, and that modifications to the disclosed embodiments, as well as other embodiments, are intended to be included within the scope of the appended claims.

What is claimed is:

1. A substrate inspecting apparatus comprising:
an image sensor that captures an image of a substrate to generate basic image data; and
a merger that divides the basic image data into first image data including a first stain area and a first non-stain area and second image data including a second stain area and a second non-stain area, and that merges the first image data and the second image data to generate merged image data including a merged stain area that represents the first stain area and the second stain area and a merged non-stain area that represents the first non-stain area and the second non-stain area.

2. The substrate inspecting apparatus of claim 1, wherein the merger determines whether the substrate is defective based on the merged image data.

3. The substrate inspecting apparatus of claim 1, wherein the merger generates the merged image data by calculating a first normal value by normalizing a sum of a brightness of the first stain area and a brightness of the second stain area and a second normal value by normalizing a sum of a brightness of the first non-stain area and a brightness of the second non-stain area.

4. The substrate inspecting apparatus of claim 3, wherein the merger calculates the first normal value by subtracting a predetermined value from the sum of the brightness of the first stain area and the brightness of the second stain area, and calculates the second normal value by subtracting the predetermined value from the sum of the brightness of the first non-stain area and the brightness of the second non-stain area.

5. The substrate inspecting apparatus of claim 3, wherein
the merged stain area has a same brightness as the first normal value, and
the merged non-stain area has a same brightness as the second normal value.

6. The substrate inspecting apparatus of claim 1, wherein the image sensor includes:
an imager that captures the image of the substrate to generate a plurality of captured image data of the substrate;
an inspector that determines whether the substrate is defective based on each of the plurality of captured image data; and
a generator that generates the basic image data based on the plurality of captured image data.

7. A method of inspecting a substrate, the method comprising:
generating basic image data by capturing an image of a substrate;
dividing the basic image data into first image data including a first stain area and a first non-stain area and second image data including a second stain area and a second non-stain area; and
merging the first image data and the second image data to generate merged image data including a merged stain area representing the first stain area and the second stain area and a merged non-stain area representing the first non-stain area and the second non-stain area.

8. The method of claim 7, further comprising:
determining whether the substrate is defective based on the merged image data.

9. The method of claim 7, wherein the generating of the merged image data includes:
calculating a first normal value by normalizing a sum of a brightness of the first stain area and a brightness of the second stain area; and
calculating a second normal value by normalizing a sum of a brightness of the first non-stain area and a brightness of the second non-stain area.

10. The method of claim 9, wherein the calculating of the first normal value and the second normal value includes:
subtracting a predetermined value from the sum of the brightness of the first stain area and the brightness of the second stain area; and
subtracting the predetermined value from the sum of the brightness of the first non-stain area and the brightness of the second non-stain area.

11. The method of claim 9, wherein
the merged stain area has a same brightness as the first normal value, and
the merged non-stain area has a same brightness as the second normal value.

12. The method of claim 7, wherein the generating of the basic image data by capturing the image of the substrate includes:
generating first basic image data by capturing an image of a first substrate; and
generating second basic image data by capturing an image of a second substrate.

13. The method of claim 12, wherein the dividing of the basic image data into the first image data and the second image data includes:
dividing the first basic image data into first first image data including a first first stain area and first second image data including a first second stain area, wherein the first second stain area has a position in the first second image data that is the same as the position of the first first stain area in the first first image data; and
dividing the second basic image data into second first image data including a second first stain area and second second image data including a second second stain area, wherein the second second stain area has a position in the second second image data that is the same as to the position of the second first stain area in the second first image data.

14. The method of claim 13, wherein the generating of the merged image data by merging the first image data and the second image data includes:
generating first merged image data including a first merged stain area representing the first first stain area and the first second stain area by merging the first first image data and the first second image data; and
generating second merged image data including a second merged stain area representing the second first stain area and the second second stain area by merging the second first image data and the second second image data.

15. The method of claim 14, wherein the generating of the merged image data by merging the first image data and the second image data further includes:
generating the merged image data including the merged stain area representing the first merged stain area and the second merged stain area by merging the first merged image data and the second merged image data.

16. The method of claim 7, wherein the generating of the basic image data by capturing the image of the substrate includes:
generating first basic image data including a first first stain area and a first second stain area by capturing an image of a first substrate; and
generating second basic image data including a second first stain area and a second second stain area by capturing an image of a second substrate, wherein the second first stain area has a position in the second basic image data that is same as the position of the first first stain area in the first basic image data, and the second second stain area has a position in the second basic image data that is same as the position of the first second stain area in the second basic image data.

17. The method of claim 16, wherein the generating of the basic image data by capturing the image of the substrate further includes:
generating the basic image data including the first stain area representing the first first stain area and the second first stain area and the second stain area representing the first second stain area and the second second stain area by merging the first basic image data and the second basic image data.

18. The method of claim 7, wherein the generating of the basic image data includes:
generating a plurality of captured image data of multiple exposure areas of the substrate; and
generating the basic image data through the plurality of captured image data.

19. The method of claim 18, wherein the generating of the basic image data further includes:
determining whether the substrate is defective based on each of the plurality of captured image data.

20. The method of claim 7, wherein
the first image data includes first information about the first stain area and the first non-stain area,
the second image data includes second information about the second stain area and the second non-stain area,
the first information includes a position of the first stain area, a size of the first stain area, a shape of the first stain area, a brightness of the first stain area, a position of the first non-stain area, and a brightness of the first non-stain area, and
the second information includes a position of the second stain area, a size of the second stain area, a shape of the second stain area, a brightness of the second stain area, a position of the second non-stain area, and a brightness of the second non-stain area.
